(19) United States
(12) Patent Application Publication
(10) Pub. No.: US 2004/0234925 A1
(43) Pub. Date: Nov. 25, 2004

(54) Dental implant or the like, comprising a core and a ceramic sleeve assembled by bonding

(76) Inventor: Andre Benhamou, Balma (FR)

Correspondence Address: YOUNG & THOMPSON, 745 SOUTH 23RD STREET, 2ND FLOOR, ARLINGTON, VA, 22202, US

(21) Appl. No.: 10/485,564

(22) PCT Filed: Jul. 17, 2002
(86) PCT No.: PCT/FR02/02544

(30) Foreign Application Priority Data
Aug. 3, 2001 (FR) 0110428

(51) Int. Cl. A61C 8/00

(52) U.S. Cl. 433/173

(57) ABSTRACT

The invention concerns a dental implant or prosthetic component. Said implant comprises a metallic core (1) and an outer ceramic sleeve (2) enclosing at least partly the core (1), both being assembled together by bonding. The outer ceramic layer consists of a sleeve (2) separate from the core (1), nested thereon by sliding and fixed by bonding, by providing therebetween a resist (3) for the adhesive with sufficient volume to absorb the impacts to which the implant is subjected but without inducing a significant clearance between the core (1) and the ceramic sleeve (2).

The invention is in the medical field and more particularly in the field of dental implants. It has for its object a dental implant or prosthetic component, comprising a metallic or synthetic core and an external ceramic sleeve.

There are known dental implants provided to be inserted at least in part in an osseous recess. To give these implants both satisfactory mechanical resistance and biological compatibility with the organic tissues of the patient, it has been proposed to provide a strong metallic core with a cladding or with an external sleeve of ceramic that can be integrated by the living organism. Reference could particularly be had to the patents FR2778091 (BENHAMOU), DE2419080 (KIRSCHNER), FR2745998 (PROSIS), FR2693900 (PROSIS), U.S. Pat. No. 4,713,006 (HAKAMATSUKA), U.S. Pat. No. 5,310,343 (HASAGAWA) and (EP0405556) (TDK).

A problem to be solved is in the connection between the core and the external ceramic sleeve. According to a first technique, this connection is carried out by means of a mass that is cohesive to ceramic fixed by heat on the core (DE2419080). According to a second technique, this connection is a mechanical connection, either by force fitting (FR2745998 and FR2693900), or by screwing (U.S. Pat. No. 5,310,343, U.S. Pat. No. 4,713,006). There has also been proposed by FR2778091 a third solution, consisting in carrying out this connection by cementing.

Generally speaking, the obtained connection is strong. However, it has become apparent that this strength could finally rely on the reliability of the connection between the core and the external ceramic layer, and to the general resistance of the implant.

Moreover, as to connections according to which the ceramic layer and the core are of separate assembled elements, a difficulty to be overcome is in the delicate centering between the ceramic layer and the core.

In the case of connection by force fitting, the drawback referred to above relates to the rigidity of the connection which is correspondingly greater. Moreover, force fitting gives rise to undesirable stresses in the assembled elements, and particularly in the ceramic element, which renders it fragile.

In the case of connection by screwing, the clearance present between the screw threads makes more difficult to this extent the centering, and requires, as in U.S. Pat. No. 4,713,006, the use of a flexible intermediate mass for absorbing this clearance.

The object of the present invention is to provide a dental implant or prosthetic component of the type mentioned above, whose connection between the core, which can be metallic or ceramic, and the external ceramic sleeve, will be firm without thereby involving a rigidity that is prejudicial to this connection. Still according to this object, there is proposed such a connection with precise centering between the core and the external ceramic layer.

The inventive step of the present invention consists generally in making the choice of a cemented connection between the core and the external ceramic sleeve. This external sleeve is formed by a sleeve separate from the core connected to this latter by sliding thereon and is fixed by cementing. This connection is effected by providing between the core and the sleeve a reserve to receive the cement, this reserve being of a volume sufficient to permit relative mobility between the sleeve and the core, so as to absorb shocks to which the implant is subjected, clearanceing a shock absorbing role permitting a function of resilience, without thereby lessening the firmness of the obtained connection, nor giving way to substantial clearance between the core and the ceramic sleeve.

It will also be seen that the sleeve, being formed independently of the core, particularly by molding, to then be fixed on the latter, is easy to obtain with dimensions relative to those of the core, for formation of the reserve.

This reserve for the reception of cement is particularly formed by a spacing between the corresponding walls of the core and the sleeve, so as to provide between them a clearance, of the order comprised between 80 to 150 microns.

To promote the adherence of the cement to the metal, the core preferably has striations.

The cement used is preferably a mono-component resin without a solvent, that is polymerized by exposure to UVA.

More particularly, this cement is preferably a thixotropic cement of a density of the order of 1.12 g/cm³ at 25° C., whose hardening time under exposure to 40 mW/cm² is of the order of 10 seconds. This cement has after polymerization a Shore hardness of the order of 75 D, with a temperature resistance comprised between −55° C. and +135° C.

Preferably, the material at the core is titanium or other metal, whilst that of the sleeve is zirconia or alumina.

The core can also be made of a synthetic material.

The present invention will be better understood and the details thereof will be made clear, from the description which follows of examples of embodiment, with reference to the accompanying drawings, in which:

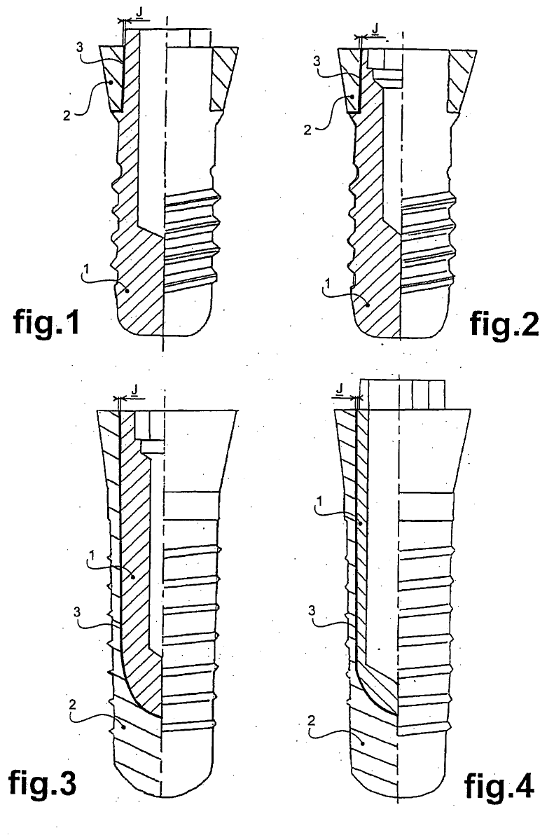

FIGS. 1 to 4 are views in longitudinal half cross-section of different respective embodiments of a dental implant according to a first embodiment of the invention.

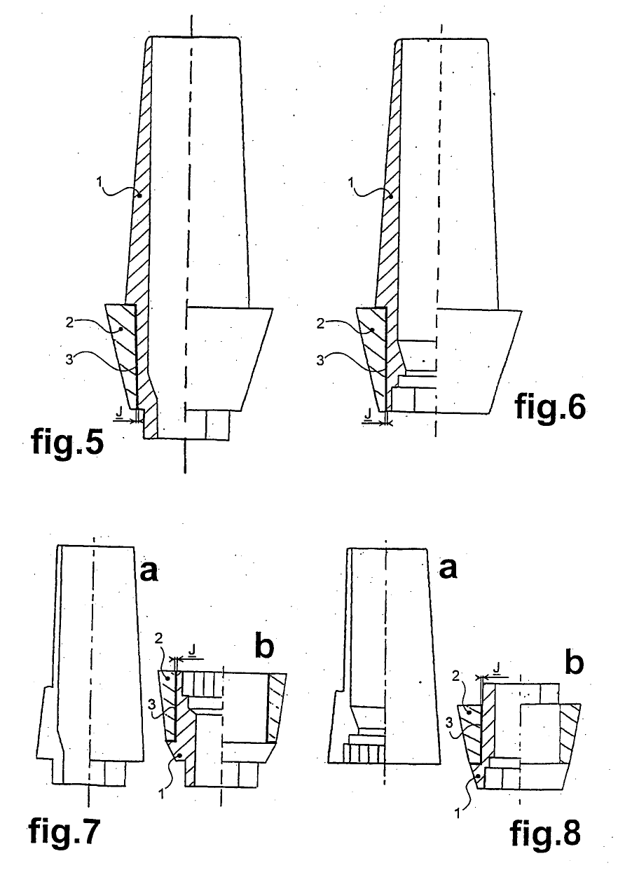

FIGS. 5 and 6 are longitudinal half cross-sectional views of a mono-block prosthetic component.

FIGS. 7 and 8 are longitudinal half cross-sectional views of different modifications respectively of embodiment of a prosthetic dental component according to a second embodiment of the invention, in which the stump is comprised by two elements, respectively a and b, provided to be assembled with each other.

In the figures, a dental implant or the like comprises a metallic core 1 and an external layer 2 of ceramic, which envelopes at least partially the core 1. The external ceramic layer is constituted by a sleeve 2 of zirconia obtained by molding, which is connected after it is produced, about the core 1, to which it is fixed by cementing.

A clearance J is provided between the corresponding facing surfaces of the core 1 and the sleeve 2, to form between these latter a reserve 3 for the reception of the cement.

1. Dental implant or the like, of the type of implant comprising a metallic or synthetic core (1) and an external ceramic sleeve (2) at least surrounding the core (1), the latter being connected to each other by cementing, characterized:
in that the external ceramic sleeve is formed of a sleeve (2) separate from the core (1), connected to this latter by slidable reception and fixed by cementing, by providing between them a reserve (3) for the cement of a volume sufficient to absorb shocks to which the implant is subjected, thereby playing a shock absorbing role, without at the same time giving rise to a substantial gap between the core (1) and the ceramic sleeve (2).

2. Implant according to claim 1, characterized:
in that the reserve (3) of cement provided between the corresponding walls of the core (1) and the sleeve (2) is formed with a spacing J between these walls of the order comprised between 80 and 150 microns.

3. Implant according to claim 1, characterized:
in that the core (1) comprises striations to promote adherence of the cement to the core.

4. Implant according to claim 1, characterized:
in that the cement is a mono-component resin without solvent, polymerizing under exposure to UVA.

5. Implant according to claim 4, characterized:
in that the cement is a thixotropic cement of a density of the order of 1.12 g/cm³ at 25° C., whose setup time under exposure to 40 mW/cm² is of the order of 10 seconds, this cement having after polymerization a Shore hardness of the order of 75D, with a temperature resistance of the order comprised between −55° C. and +135° C.

6. Implant according to claim 1, characterized:
in that the material of the core (1) is metallic.

7. Implant according to claim 1, characterized:
in that the material of the core (1) is synthetic.

8. Implant according to claim 1, characterized:
in that the material of the sleeve (2) is zirconia.
